(19) United States
(12) Patent Application Publication
(10) Pub. No.: US 2009/0324846 A1
(43) Pub. Date: Dec. 31, 2009

(54) POLYENE PIGMENT COMPOSITIONS FOR TEMPORARY HIGHLIGHTING AND MARKING OF PRINTED MATTER

(75) Inventors: John Tomaschke, San Diego, CA (US); George Brown, Ramona, CA (US)

Correspondence Address: BioTechnology Law Group;12707 High Bluff Drive, Suite 200, San Diego, CA, 92130-2037, US

(73) Assignee: B&T TECHNOLOGIES, LLC, San Diego, CA (US)

(21) Appl. No.: 12/146,400

(22) Filed: Jun. 25, 2008

(51) Int. Cl. C09D 11/02; C08J 7/18

(52) U.S. Cl. 427/553; 106/31.6

(57) ABSTRACT

Disclosed herein are compositions comprising a polyene compound and an additive selected from the group consisting of antioxidant, surfactant, oil, wax, solvent, and a combination thereof. Also disclosed herein are methods of temporarily marking a surface comprising marking the surface with a composition as disclosed herein, where the marking has a color intensity; and exposing the surface to ambient light and ambient air, whereby the color intensity of the marking decreases over a period of time. Further, disclosed herein are markers comprising a composition as disclosed herein.

### FIELD OF THE INVENTION

The present invention relates to the temporary highlighting of printed matter with liquid or solid highlighting compositions containing polyene pigments. These non-toxic pigments may be obtained from either natural sources or synthetic equivalents and are safe for use by school children.

### BACKGROUND OF THE DISCLOSURE

U.S. Pat. No. 5,055,498 relates to erasable crayons fabricated from solid marking compositions incorporating polyethylene resins.

International Patent WO/1993/024580 features erasable marking compositions in solid form which can be applied to and erased from paper substrates. One aspect of this invention includes a solid erasable highlighting composition containing a block copolymer, wax, and fluorescent pigment.

International Patent WO/1995/004785 relates to water soluble crayon composition comprising ethoxylated alcohol, a pigment or dye, and a filler material. Markings onto various surfaces are removable by water.

U.S. Pat. No. 5,453,120 describes erasable fluorescent marking materials and markers made therefrom in which a wax-based vehicle contains a suspension of fluorescent pigment particles.

International Patent WO/1985/0007782 and its counterpart U.S. Pat. No. 4,681,471 relate to kits of colored fluid marking devices in combination with means for eradication of the marks. An example is arylmethane-based coloring marks eradicated with sodium metabisulfite reducing agent from a variety of surfaces.

U.S. Pat. No. 5,362,167 features aqueous-based erasable marking compositions containing a latex emulsion and a water insoluble pigment. Included are highlighters for paper substrates.

International Patent WO/1996/039302 and its counterpart U.S. Pat. No. 6,066,439 describe temporary marking and printing of various surfaces where a photoerasable colorant composition is employed. The photoerasable colorant composition comprises a mutable colorant and an ultraviolet radiation transorber. Ultraviolet light irradiation renders the colored marking colorless.

U.S. Pat. Nos. 5,324,131 and 5,427,278 relate to method and apparatus, respectively, for removing water-based, non-pigmented highlighting markings from a paper surface. The color removing agents consist of bleaches and other oxidizing chemicals.

There are thus three basic approaches in the prior art for removing colored highlighting or marking on printed paper substrates: physical contact (rubber eraser), chemical treatment, and ultraviolet light irradiation. Each of these techniques suffers from one or more disadvantages. Erasure, when done repeatedly, erodes the surface of printed matter including the printing ink which resides therein. Chemical treatment involves use of toxic, corrosive, or irritating compounds which would be unsafe for children. Ultraviolet light irradiation carries with it the risk of eye injury as well as complexity and would also be unsuitable for children. It should be further mentioned that using water to remove water soluble crayon markings on paper result in unsatisfactory wrinkling damage of the paper substrate. All of the aforementioned color highlighting or marking removal techniques for paper substrates require a time consuming additional treatment step. In particular, this additional removal step is very impractical for the quantities of textbook highlighting accumulated during school sessions lasting from one to nine months.

Clearly, the need exists for a means of highlighting or marking textbooks and other printed matter such that this highlighting or marking disappears over controllable time periods without the need for additional dangerous or time consuming treatments.

### SUMMARY OF THE INVENTION

Disclosed herein are compositions comprising a polyene compound and an additive selected from the group consisting of antioxidant, surfactant, oil, wax, solvent, and a combination thereof. In some embodiments, the polyene compound is a carotenoid polyene. In certain embodiments, the polyene compound is selected from the group consisting of antheraxanthin, astacin, astaxanthin, canthaxanthin, capsanthin, carotenes, cryptoxanthin, diatoxanthin, didehydroastaxanthin, echinone, lutein, lycopene, lycophyll, lycoxanthin, rhodopin, rhodoviolascin, rhodoxanthin, rubixanthin, spheroidene, spheroidenone, spirilloxanthin, and their saccharide derivatives. Some of the polyene compounds disclosed herein are naturally occurring polyene compounds, whereas others are synthetic polyene compounds.

In some embodiments, the antioxidant is selected from the group consisting of BHT (2,6-bis[1,1-dimethylethyl]-4-methylphenol), ascorbyl palmitate, and the like.

In some embodiments, the oil is vegetable oil.

In certain embodiments, the wax is selected from the group consisting of candle wax, paraffin Fischer Tropsche wax, carnauba wax, paraflint wax, and the like, and combinations thereof.

In some embodiments, the solvent is an aqueous solvent. In certain embodiments, the solvent is a combination of water and an organic solvent. In further embodiments, the organic solvent is an alcohol.

In some embodiments, the compositions disclosed herein further comprise a sublimable organic compound, which may include a compound selected from the group consisting of camphene, camphor, p-dichlorobenzene, p-hydroxybenzaldehyde, quininone, quinuclidine, and trioxane, and the like.

Also disclosed herein are methods of temporarily marking a surface comprising marking the surface with a composition of as disclosed herein, where the marking has a color intensity; and exposing the surface to ambient light and ambient air, whereby the color intensity of the marking decreases over a period of time. In some embodiments, the marking disappears over a period of time, which can be a period of months or a period of hours.

Further, disclosed herein are markers comprising a composition as disclosed herein. In some embodiments, the marker is a crayon, whereas in other embodiments, the marker is a highlighter. In some embodiments, the marker further comprises a wick.

### DETAILED DESCRIPTION OF THE EMBODIMENTS

In one aspect, disclosed herein are colored compositions that lose their color over a period of time, highlighter pens and devices that use these compositions, and methods of making and using the highlighter pens and devices. In some embodiments, disclosed herein are compositions comprising a polyene compound and an additive selected from the group consisting of antioxidant, surfactant, oil, wax, solvent, and a combination thereof.

In some embodiments, the polyene compound is a carotenoid polyene. In some embodiments, carotenoid polyenes, which are found widely distributed in nature, are used in the compositions disclosed herein. Carotenoids are defined by their chemical structure. The majority carotenoids are derived from a 40-carbon polyene chain, which could be considered the backbone of the molecule. A “polyene chain” is a chain of carbon atoms comprising repeating single and double bonds. In some embodiments, a polyene chain comprises a chain of the following repeating unit: —CH₂—CH═CH—. In some embodiments, the polyene compound comprises a sequence of at least ten alternating single and double bonds, i.e., a sequence of at least ten of the aforementioned repeating unit.

The polyene chain may be terminated by cyclic end-groups (rings) and may be complemented with oxygen-containing functional groups. The hydrocarbon carotenoids are known as carotenes, while oxygenated derivatives of these hydrocarbons are known as xanthophylls. Beta-carotene, the principal carotenoid in carrots, is a familiar carotene, while lutein, the major yellow pigment of marigold petals, is a common xanthophylls.

An example of one such common carotenoid is beta-carotene, also known as pro-vitamin A, which is found in many plants, fruits, and microorganisms. The color of the carotenoid family of pigments ranges from yellow to red. These compounds are generally considered to be safe to humans and the environment, and consequently, are commonly used as food, in or as pharmaceuticals, and cosmetic colorants. While most carotenoid polyenes are obtained from natural sources, in some embodiments, the carotenoid polyene used in the compositions disclosed herein is obtained from synthetic sources.

Examples of carotenoids include, but are not limited to, antheraxanthin, astacin, astaxanthin, canthaxanthin, capsanthin, carotenes, cryptoxanthin, diatoxanthin, didehydroastaxanthin, echinone, lutein, lycopene, lycophyll, lycoxanthin, rhodopin, rhodoviolascin, rhodoxanthin, rubixanthin, spheroidene, spheroidenone, spirilloxanthin, and their saccharide derivatives. The color of carotenoid pigments is due to the long chromophore of the polyene chain. Specifically, the uninterrupted series of conjugated double bonds is responsible for the light absorbing properties. It is this same chemical structure that is also responsible for the sensitivity to oxidative and/or other chemical degradation processes caused or mediated by heat, light, bleaches, and acids.

In some embodiments, the polyene compound used in the compositions disclosed herein is a naturally occurring polyene compound, whereas in other embodiments, the polyene compound is a synthetic polyene compound. A “naturally occurring compound” is a compound that is found in nature, for example in plants or in animals. The naturally occurring compounds used in the compositions disclosed herein are not chemically altered. Instead, they are isolated from their natural source and purified. In some embodiments, a polyene compound is synthesized such that its chemical structure is identical to a naturally occurring compound. These synthetic compounds are also considered “naturally occurring polyene compounds” even though they were synthesized from laboratory reagents and commercially available precursors. A “synthetic polyene compound” is a compound that is synthesized in a laboratory and is not structurally identical to a naturally occurring compound. Some synthetic polyenes are derivatives of naturally occurring polyenes. Derivatives are obtained by methods known to those of skill in the art, for example, by adding a protecting group, removing a substituent, adding a new substituent, and the like.

It has now been discovered that carotenoid pigment coloring on printed paper substrates, such as a textbooks, used in a typical indoor environment can be made to disappear controllably timewise through the selection of a proper carotenoid compound. While not bound by any particular theory, it is postulated that the longer the conjugated double bond backbone is, the more rapid is its oxidative degradation and thus color loss. This discovery allows creation of particular catotenoid compositions to achieve color highlighting or marking lifetimes for paper substrates. It is believed that the oxygen present in air and to a certain extent light exposure are causative in the carotenoid degradation and resultant color loss for these highlighting and marking applications. As an example, it was found that highlighting with compositions containing lycopene and beta-carotene pigments which possess eleven conjugated double bond backbones lose color more rapidly than lutein which has a ten conjugated double bond backbone. Even more dramatically, a highlighting composition containing crocin pigment, (a carotenoid from gardenia fruit) which has only seven conjugated double bonds in its backbone, was found to be impractically resistant to color degradation. Concentration of any one carotenoid may also be used to advantage since it was found that the lower the concentration used in the composition, the more rapid is its color loss.

An especially preferred application of this new technology is the temporary highlighting or marking of textbooks and other printed material belonging to schools, colleges, and universities in which this printed matter must be returned or resold back to the institution within intervals of months and in its original unmarked condition.

In the compositions disclosed herein, the carotenoid compound is mixed to provide a homogenous mixture. A homogenous mixture is one in which the local concentration of the carotenoid compound, i.e., the concentration of the carotenoid compound within a small volume fraction of the total mixture, is nearly identical to the concentration of the carotenoid compound in the mixture. Methods of creating homogenous solutions of organic compounds are well-known in the art. Some examples include the following, although other methods, not mentioned here, can also be used.

In some embodiments, the compositions disclosed herein are liquids, whereas in other embodiments, the composition is substantially solid. Liquid compositions are those in which the carotenoid polyene compound is dissolved in a liquid solvent, such as water, alcohol, an organic solvent, or combinations thereof, and a homogenous solutions is obtained. To obtain substantially solid compositions, the carotenoid polyene compound is mixed with a wax or wax mixture, as discussed herein. By “substantially solid” it is meant that at room temperature, the composition holds its shape. However, a user can change the shape of the composition by applying some pressure. Substantially solid compositions have the consistency and malleability similar to, for example, candle, crayon, and paraffin.

Some carotenoid compounds are water soluble. These compounds are dissolved in the desired amount of water, i.e., enough water to provide the concentration of the pigment needed for the particular task, and the solution is mixed well to obtain a homogenous solution.

Certain carotenoid compounds are soluble in organic solvents. For these compounds, a suitable organic solvent is selected and the compound is mixed therein until a homogenous solution is obtained. In some of these embodiments, wax or oil, such as vegetable oil, can be added to the mixture, or that the carotenoid compound can be exclusively mixed in the wax or vegetable oil. Examples of vegetable oils suitable for use in the compositions disclosed herein include, but are not limited to, oil of almond, canola, carrot, castor, corn, cottonseed, grapeseed, hazelnut, olive, palm, peanut, poppyseed, rice bran, safflower, sesame, soybean, sunflower, and wheatgerm.

Examples of wax suitable for use in the compositions disclosed herein include, but are not limited to, candle wax, paraffin, Fischer Tropsche wax, carnauba wax, paraflint wax, microcrystalline waxes, ozokerite, and silicone wax. Examples of natural sources for wax include: bayberry, beeswax, candelilla, carnauba, castor, Chinese wax, esparto, Japan wax, lanolin, ouricury, rice bran, shellac, and soy. In some embodiments, the carotenoid compound is emulsified in the desired solvent. In other embodiments, the carotenoid compound is present in the solvent as a colloidal mixture.

It is desirable for the carotenoid pigment particles, colloids, or emulsion droplets, to be very fine, i.e., have relatively small radii, such that dissolution or suspension is efficient and uniform. Any dry source as well as vegetable oil containing source is effective for the uses disclosed herein as long as the other ingredient(s), if present, do not interfere with the desired solution or normally expected color loss properties.

In some embodiments, the compositions disclosed herein are used to prepare crayons for highlighting and marking. For these compositions, readily available pharmaceutical grade sources of carotenoids in either oil or dry powder form may be used. These sources may be either in bulk or in the form of individual capsules. For example, in one embodiment, a composition is made using oil-containing gel capsules containing known quantities of carotenoid. In some embodiments, the wax or wax mixture to be used contains no other pigments or colorants or substances that are deleterious to the processes disclosed herein and have a melting point of at least 45° C. While not particularly critical, the wax or wax mixture can possess a blend of strength and hardness yet be soft enough to allow ease of marking and highlighting. Additional ingredients may be used that aid in the blending or other processability of the crayon composition. Examples include petrolatum to provide a softer crayon, antioxidants as preservative, and mold-release agents to aid in manufacture.

In some embodiments, the wax or wax mixture is first heated to at least the melting temperature of the wax itself (typically in the range of 50-80° C.), then the carotenoid pigment source and other ingredients are mixed in until fully dissolved or evenly dispersed. Crayons are then fabricated by pouring the molten mixture into a mold of the desired dimensions and allowing it to cool. The crayon solid stick serves as its own marking or highlighting implement.

In another embodiment, a portion of the above wax or wax mixture is replaced by a sublimable organic compound in order to reduce the quantity of wax residue left on the paper substrate after crayon highlighting or marking. Examples of such sublimable organic compounds include, but are not limited to, camphene, camphor, p-dichlorobenzene, p-hydroxybenzaldehyde, quininone, quinuclidine, and trioxane.

In another embodiment, the compositions disclosed herein are used to prepare felt-tip type highlighting implements. In the case of fluid highlighting or marking compositions that would be utilized in a felt-tip type highlighter implement, the same sources of carotenoid pigments discussed above are used in a substantially aqueous solution. By “substantially aqueous solution” it is meant that the solution comprises a solvent system, i.e., a mixture of solvents, that is at least 50% water. A solvent system that is completely, i.e., 100% water, is still considered a “substantially aqueous solution.”

Since carotenoids generally have little or no water solubility, when vegetable oil sources are used, in some embodiments they are made into emulsions with the aid of a surfactant or emulsifying agent. The particular surfactant or emulsifying agent used is not critical as long as the desired solution properties are obtained. Even more preferred are the dry sources of carotenoids intended especially for efficient water dispersion. These sources in general yield a higher quantity of carotenoid in solution and consequently greater color intensity. Use of surfactants with these solutions is optional. Examples of surfactants or emulsifying agents that can be used in the compositions disclosed herein include include nonionic, anionic, cationic, and zwitterionic species. Specific examples include but are not limited to: alkyl glucosides, cocoamide monoethanolamines, fatty alcohols, polyethoxylated tallow amine, polyoxyethylene fatty acid esters; Brij 76®, Igepal® CO, Planet Ultra®, Polysorbate 80®, Pluronics®, Tetronics®, Triton X-100®, and Tween 40®; fatty acid salts, sodium benzene sulfonate, sodium dodecylsulfate, Zonyl® FSA, and FSE; alkyl phosphonium halides, benzyl phosphonium halides, benzalkonium halides, benzethoniumchloride, cetyl pyridinium chloride, and cetyl trimethylammonium bromide; dodecyl betaine, dodecyl dimethylamineoxide, and lecithins.

As with the crayon compositions, antioxidants may be included as a preservative in increasing shelf life of the composition. Examples of antioxidants useful in the compositions disclosed herein include, but are not limited to,: ascorbic acid and its esters, flavonoids, glutathione, isothiocyanates, phenols, polyphenols, propyl gallate, phytic acid, tocopherols; BHA (tert.-butyl-4-hydroxy anisole), BHQ (tert-butyl hydroquinone), BHT (2,6-bis[1,1-dimethylethyl]-4-methylphenol), and metabisulfites. Other ingredients such as alcohols, glycols, or additional compounds may also be included for the purpose of optimizing solution or coating properties. Examples of alcohols that can be used in the compositions disclosed herein include the aliphatic C1 through C11 family and its various isomers, methoxy alkanols, and phenylalkanols. Examples of glycols include glycerin, and C2 through C6 diols.

In another aspect, disclosed herein is a method of temporarily marking a surface comprising marking the surface with a composition as disclosed herein, where the marking has a color intensity; and exposing the surface to ambient light and ambient air, whereby the color intensity of the marking decreases over a period of time.

In some embodiments, the marking step comprises contacting the surface with a composition as disclosed herein. In some embodiments, the compositions disclosed herein are colored. Therefore contacting a surface with the compositions disclosed herein causes the surface to attain the color of the composition. The marking step in the methods disclosed herein is similar to writing on a surface with a crayon or highlighting a text with a commercially available highlighter or felt-tip pen or marker.

In some embodiments, normal use of the marked surface is sufficient for exposing the surface to ambient light and ambient air. In other embodiments, the surface is exposed to ambient light for an extended amount of time, for example, by laying it in the sunlight for a few hours.

Preferably, subsequent to exposure to ambient light and air, the marking disappears over a period of time. In some embodiments, the period of time is a period of months, whereas in other embodiments, the period of time is a period of hours.

In some embodiments, the surface being marked is a paper. In some of these embodiments, the paper is a page of a textbook. However, those of skill in the art recognize that any surface can be marked with the compositions disclosed herein, or using the disclosed methods.

In another aspect, disclosed herein are markers comprising a composition as disclosed herein. The marker can be any device that can be used to hold an amount of the compositions as disclosed herein and transfer a portion of the composition to a surface. In some embodiments, the marker is similar to a device that is commercially available and is used for marking surfaces, for example, a pen, a felt-tip pen, a crayon, a wax pencil, a marker, a highlighter, and the like.

In some embodiments, the marker comprises a wick. As used herein, a “wick” is a bundle of fibers or a loosely twisted, braided, or woven cord, tape, or tube that by capillary attraction draws up the compositions as disclosed herein in the marker. For example, a felt-tip pen or a highlighter comprises a wick at its center to transfer the ink to the surface.

In other embodiments, the marker does not have a wick. In these embodiments, the marker comprises a container reservoir that holds the compositions as disclosed herein. In some embodiments, the container reservoir is capped with a flexible, for example rubber, tip. When pressure is applied to the container reservoir, for example by squeezing it or by squeezing the body of the marker which will in turn apply pressure on the reservoir, the composition within the reservoir exits the flexible tip. Once the pressure is removed, the flexible tip seals the reservoir. These embodiments are useful in avoiding the drying of the composition at the tip of the marker, which result in less of the composition being deposited on a surface and thereby having a faint mark on the surface.

### EXAMPLES

The following examples are illustrative of the techniques embodying the compositions and methods disclosed herein for producing temporary highlighting or marking in textbooks and other printed matter and are not intended to be limiting in scope. For the examples listed below, a college textbook entitled “The Art of Public Speaking” (Author Stephen E. Lucus: 8^{th} Edition: McGraw Hill 2004: printed on acid-free paper) was utilized as the substrate to be highlighted and is hereafter referred to as the standard textbook.

### Example 1

The contents of two softgel capsules of beta-carotene (30 mg total in carrot oil; Schiff Products) were added to 16 grams of uncolored candle wax, melted, and mixed well to create a colored stock solid source. 120 mg BHT (2,6-bis[1,1-dimethylethyl]-4-methylphenol) was added to 20 grams of uncolored candle wax, melted and mixed well to yield an antioxidant stock solid source. These two stock solids and additional candle wax were weighed out into 4 glass test tubes, mixed well after melting, then poured into four 7/16 inch i.d. by 2¼ inch long paper cylinder molds and allowed to cool. The resultant wax crayons contained 7.5 mg beta-carotene each with 0-6 mg BHT antioxidant in a total mass of 5 grams. Each of the four crayons was marked onto three lines of standard textbook print as strong intensity, clear yellow colored highlighting. After ambient closed book storage, the highlighting was examined repeatedly to determine the time to reach complete color loss. The results are shown in the table below. The results show that the color life time is increased with increasing amounts of the antioxidant.

| BHT (mg) | Time (months) |
|---|---|
| 0 | 1.75 |
| 0.6 | 2.75 |
| 2.0 | 3 |
| 6.0 | 3.75 |

### Example 2

Four crayons were fabricated in the manner of EXAMPLE 1 except that each contained 15 mg of beta-carotene with varying amounts of BHT antioxidant and petrolatum (white, USP). After marking the standard textbook print there was observed a strong intensity yellow-orange colored highlighting for all four crayons. Color life time at ambient closed book storage was measured. The results are set forth in the table below.

| Petrolatum (grams) | BHT (mg) | Time (months) |
|---|---|---|
| 1 | 0 | 5 |
| 0.5 | 6 | 5 |
| 1 | 6 | 6 |
| 2 | 6 | 8 |

The results show that addition of the highest amount of petrolatum extended the color lifetime and also produced crayons with less marking pressure needed.

### Example 3

Four crayons were fabricated in the manner described in EXAMPLE 1 except a soybean oil based gel capsule source of beta-carotene (Radience Vitamins) was used. After marking the standard textbook print, the highlighting varied from very strong red-orange to moderately strong intensity yellow-orange color. The results are shown in the table below.

| Beta-Carotene (mg) | BHT (mg) | Time (months) |
|---|---|---|
| 60 | 0 | 6 |
| 30 | 0 | 4 |
| 30 | 60 | 5.25 |
| 15 | 0 | 3 |

### Example 4

Three crayons were fabricated as in EXAMPLE 3 except varying amounts of ascorbyl palmitate (Country Life) were substituted for BHT as the antioxidant and the total mass of the crayon was 4 grams. After marking the standard textbook print, the highlighting was observed to be a strong intensity yellow-orange color for all three cases. The results are shown in the table below.

| Beta-Carotene (mg) | ascorbyl palmitate (mg) | Time (months) |
|---|---|---|
| 15 | 0 | 2.5 |
| 15 | 30 | 5.5 |
| 15 | 235 | 8 |

### Example 5

15 mg of a powder capsule source of beta-carotene (Nature's Way Products Inc.) was mortar ground, mixed into 4 grams of melted candle wax and fabricated into a crayon as in the manner of EXAMPLE 1. After marking the standard textbook print, the highlighting was observed to be a medium intensity yellow-orange color and the color loss time was 4.5 months.

### Example 6

6 mg of lutein (Nature's Bounty, Inc. corn oil softgel capsule) was mixed into 2 mL of 91% by vol. isopropyl alcohol as a suspension. This suspension was brushed (fine water color paintbrush) onto the standard textbook print as a medium intensity yellow-orange highlighting. The color loss time was observed to be 5 months.

### Example 7

15 mg of the beta-carotene of EXAMPLE 1 was mixed well with 4 mL distilled water containing 1 drop of a coconut oil based surfactant (Planet Inc. Ultra) and allowed to settle. The top layer of this solution was brushed onto the standard textbook print as a medium intensity red-orange highlighting. The color loss time was observed to be 7 months.

### Example 8

5 mg of lycopene (Nature's Bounty Inc. soy oil gel capsule) was mixed with 2 mL alcohol as a suspension. This suspension was brushed onto the standard textbook print as a medium-light intensity orange highlighting. The color loss time was 3 months.

### Example 9

15 mg of the beta-carotene source of EXAMPLE 5 was well mixed with 5 mL distilled water and 1 drop of Planet surfactant. After settling, the liquid portion was brushed onto the standard textbook print as a medium-light intensity red-orange highlighting. The color loss time was 5 months.

### Example 10

1.50 grams of 1% Altratene WSC-FF powder beta-carotene (Allied Biotech Corp.) was mixed well into 12.5 mL distilled water and was syringe injected into the reservoir of an emptied and thoroughly cleaned commercial felt-tip highlighter marker. This highlighter was used to highlight the standard textbook print with strong intensity yellow color. The color loss time was 9 months.

### Example 11

0.75 grams of 5% Altratene WSC-FF powder (Allied Biotech Corp.) was mixed well with 15 mL distilled water containing 2 drops of Planet surfactant. This stock solution was subsequently diluted with distilled water by ½, ¼, and ⅛, and pipette loaded into the reservoirs of cleaned commercial felt-tipped highlighters. These were then used to highlight a separated page of the standard textbook print in yellow-orange color with intensities ranging from light to strong. An accelerated air oxidation test was performed by blowing 90° C., 30 mph air onto this page perpendicularly. The results are shown in the table below.

| Dilution | Color Intensity | Color Loss Time (hrs) |
|---|---|---|
| Stock | strong | 16.5 |
| ½ | medium-strong | 9.3 |
| ¼ | medium | 4 |
| ⅛ | light | 1.9 |

### Comparative Example 12

0.25 grams of crocin (gardenia yellow 80% powder, Guilin Zhenda Bio-tech Co. Ltd.) was dissolved completely into 100 mL of distilled water containing 20 drops Planet surfactant. A portion of this intense yellow-orange solution was syringe injected into the reservoir of an emptied cleaned commercial highlighter marker. Highlighting was made on the standard textbook print with strong intensity yellow color. After 5 months, virtually no color loss was observed thus supporting the hypothesis that short (seven in this case) conjugated double bond backbone carotenoids are much more resistant to degradative color loss than the longer conjugated structures of the preferred carotenoids.

### Example 13

0.60 grams of 5% Altratene WSC powder was mixed with 5 mL of naptha hydrocarbon solvent and ground in a mortar. The intensely colored supernatant was withdrawn then added dropwise to a 175 mL Pyrex dish containing 3 mL distilled water and 2 drops of Planet surfactant with stirring. This mixture was then evaporated while stirring with the dish in contact with a boiling water bath in order to remove the naptha solvent. The resultant emulsion and its water diluted companion solutions were brushed onto the standard textbook print and subjected to an accelerated exposure via indirect sunlight on a table top. The results are shown in the table below.

| Dilution | Color Intensity | Color Loss Time (hrs) |
|---|---|---|
| Stock | strong | 75 |
| ½ | medium-strong | 46 |
| ⅓ | medium | 34 |
| ¼ | medium-light | 24 |

The preferred wax-based compositions are processable using commercially available crayon mold cavities since the waxes and other ingredients are compatible with this equipment. The crayons made by this invention are sufficiently strong to perform as self-supporting highlighting and marking implements. The preferred aqueous-based compositions can be used in commercially available capillary feed highlighters or markers. The fiber tip is attached to the fluid reservoir may be made for example, polyester, acrylonitrile, or other commonly used polymers.

It is to be understood that modifications to the above compositions and applications of same may be performed without departing from the scope of the invention. It is therefore intended that the matter presented in the description and examples above are not limiting but rather illustrative in nature.

What is claimed is:

1. A composition comprising a polyene compound and an additive selected from the group consisting of antioxidant, surfactant, oil, wax, solvent, and a combination thereof.

2. The composition of claim 1, wherein the polyene compound is a carotenoid polyene.

3. The composition of claim 1, wherein the polyene compound is selected from the group consisting of antheraxanthin, astacin, astaxanthin, canthaxanthin, capsanthin, carotenes, cryptoxanthin, diatoxanthin, didehydroastaxanthin, echinone, lutein, lycopene, lycophyll, lycoxanthin, rhodopin, rhodoviolascin, rhodoxanthin, rubixanthin, spheroidene, spheroidenone, spirilloxanthin, and their saccharide derivatives.

4. The composition of claim 1, wherein the polyene compound is beta-carotene or lycopene.

5. The composition of claim 1, where in the antioxidant is selected from the group consisting of ascorbic acid and its esters, flavonoids, glutathione, isothiocyanates, phenols, polyphenols, propyl gallate, phytic acid, tocopherols; BHA (tert.-butyl-4-hydroxy anisole), BHQ (tert-butyl hydroquinone), BHT (2,6-bis[1,1-dimethylethyl]-4-methylphenol), metabisulfites, and combinations thereof.

6. The composition of claim 1, wherein the oil is vegetable oil selected from the group consisting of almond oil, canola oil, carrot oil, castor oil, corn oil, cottonseed oil, grapeseed oil, hazelnut oil, olive oil, palm oil, peanut oil, poppyseed oil, rice bran oil, safflower oil, sesame oil, soybean oil, sunflower oil, wheatgerm oil, and combinations thereof.

7. The composition of claim 1, wherein the wax is selected from the group consisting of candle wax, paraffin, Fischer Tropsche wax, carnauba wax, paraflint wax, microcrystalline waxes, ozokerite, and silicone wax, and combinations thereof.

8. The composition of claim 1, wherein the solvent is a combination of water and an organic solvent.

9. The composition of claim 8, wherein the organic solvent is an alcohol.

10. The composition of claim 1, further comprising a sublimable organic compound.

11. The composition of claim 10, wherein the sublimable organic compound is selected from the group consisting of camphene, camphor, p-dichlorobenzene, p-hydroxybenzaldehyde, quininone, quinuclidine, and trioxane.

12. The composition of claim 1, wherein the polyene compound comprises a sequence of at least ten alternating single and double bonds.

13. The composition of claim 1, wherein the poylene compound is in a substantially aqueous emulsion.

14. The composition of claim 7, wherein the composition is substantially solid.

15. A method of temporarily marking a surface comprising:
marking the surface with a composition of claim 1, wherein the marking has a color intensity; and
exposing the surface to ambient light and ambient air, whereby the color intensity of the marking decreases over a period of time.

16. The method of claim 15, wherein the marking disappears over a period of time.

17. A marker comprising a composition of claim 1.

18. The marker of claim 17, wherein the marker is a crayon.

19. The marker of claim 17, wherein the marker is a highlighter.

20. The marker of claim 19, further comprising a wick.
